(19) United States
(12) Patent Application Publication
(10) Pub. No.: US 2010/0037249 A1
(43) Pub. Date: Feb. 11, 2010

(54) Supplying Video Data to Mobile Devices

(75) Inventor: Peter Vassilev Sedeffow, London (GB)

Correspondence Address: RICHARD M. GOLDBERG, 25 EAST SALEM STREET, SUITE 419, HACKENSACK, NJ, 07601, US

(73) Assignee: SAFFRON DIGITAL LIMITED, London (GB)

(21) Appl. No.: 12/537,565

(22) Filed: Aug. 7, 2009

(30) Foreign Application Priority Data
Aug. 9, 2008 (GB) 08 14 632.6

(51) Int. Cl. H04N 7/16; H04N 7/12

(52) U.S. Cl. 725/8; 725/62; 375/240.01; 375/E07.076

(57) ABSTRACT

Video data is supplied from a plurality of video material suppliers (102, 103) to a plurality of mobile devices (107-109). Original video data is requested and received, and a data store (303) is arranged to store additional video data. A processing system (304) analyses original coding characteristics of the original video data received via second interface (302) and selects additional video data from the data store (303). The additional video data is coded in accordance with the original coding characteristics to produce coded additional data and the coded additional data is combined with the original video data, to produce combined video output data.

### CROSS REFERENCE TO RELATED APPLICATIONS

This application claims priority from United Kingdom patent application No 08 14632,6 filed Aug. 9, 2008, the entire disclosure of which is incorporated herein by reference in its entirety.

### BACKGROUND OF THE INVENTION

1. Field of the Invention

The present invention relates to apparatus for supplying video data to mobile devices, of the type comprising a plurality of video material suppliers; a video processing station and a plurality of mobile devices configured to request video material from said suppliers via said video processing station.

The present invention also relates to a method of supplying video data to mobile devices of the type comprising the steps of receiving a request for video data, receiving original video data in a form compatible with operational characteristics of the requesting mobile device and relaying video data to the requesting mobile device.

2. Description of the Related Art

Procedures for the downloading of video files displayable on mobile devices are described in the applicant's co-pending British patent application No U.S. Ser. No. 12/113,403. When material of this type is downloaded a specific payment may be made for the material itself or, alternatively revenue may be generated from transmission charges.

Given the wide availability of video material on the Internet, many users of computer equipment have become used to obtaining video material without making a payment. It is also well known on the Internet for revenue to be generated from advertisements as an alternative to a direct payment being made. It is therefore considered desirable to provide similar techniques for mobile devices.

A problem with displaying advertisements on mobile devices is that they are generally only provided with a relatively small screen (particularly mobile cellular telephones) therefore it is usually possible to show a single image window whereas computer display screens may show several windows, allowing advertisements to be selected and transmitted in real-time. If an advertisement is to be included in a video clip, it may be shown before or after the clip, in a fashion substantially similar to advertisements being included with movies supplied on video tape or DVD etc. Thus, an editing exercise is necessary in which the advertisements are added to the existing video material for subsequent distribution. However, this introduces a further problem in that many different schemes are presently in use for the coding and decoding of video material with differing devices having differing technical capabilities. Thus, if the additional material to be added to the requested video has been processed using techniques that differ from those adopted for the original material, a noticeable glitch may be present as the material switches from that added to or from the original source. Furthermore, in extreme cases, the playing of the video clip may cause equipment failure or alternatively after the material has been added, it is possible that the material is not playable at all.

### BRIEF SUMMARY OF THE INVENTION

According to a first aspect of the present invention, there is provided a video processing apparatus for supplying video data from a plurality of video material suppliers to a plurality of mobile devices, comprising: a first interface for receiving a request from a mobile device for video data; a second interface for requesting and receiving original video data; a data store arranged to store additional video data; and a processing system, said processing system having: an analysis of sub-system for analysing original coding characteristics and original video data received via said second interface; a selection sub-system for selecting additional video data from said data store; a coding sub-system for coding said additional video data in accordance with said original coding characteristics to produce coded additional data; and a combining sub-system for combining said coded additional data with the original video data, to produce combined video output data.

In a preferred embodiment, the analysis sub-system identifies a particular coding and decoding CODEC. Preferably, the analysis sub-system identifies a specific profile for the identified CODEC. Preferably said profile defines sample rates and sample definitions.

In a preferred embodiment, the analysis sub-system identifies a header before the start of the video data. Preferably, the coded data is combined between the header and the original video data.

According to a second aspect of the present invention, there is provided a method of supplying video data to mobile devices, comprising the steps of: receiving a request for video data; accepting a supply of original video data in a form compatible with operational characteristics of the requesting mobile device; analysing the original video data to determine characteristics of said original video data; reading additional video data from storage; coding said additional video data in accordance with said coding characteristics to produce coded video data; combining said coded video data with said original video data to produce combined video data; and supplying said combined video data in response to said request.

### BRIEF DESCRIPTION OF THE SEVERAL VIEWS OF THE DRAWINGS

FIG. 1 shows an environment for the supply of video data to mobile devices;

FIG. 2 illustrates a protocol diagram for operations performed within the environment of FIG. 1;

FIG. 3 shows a video processing station of the type identified in FIG. 1;

FIG. 4 shows a preferred implementation for the processing system identified in FIG. 3;

FIG. 5 shows an alternative embodiment for the processing system identified in FIG. 3;

FIG. 6 shows an example of procedures for analysing the type of video asset received;

FIG. 7 illustrates operations performed by the processing system identified in FIG. 3; and

FIG. 8 shows data displayed on a mobile device, in response to a user selecting encoded video data using procedures identified in FIG. 7.

### DETAILED DESCRIPTION OF THE PREFERRED EMBODIMENTS

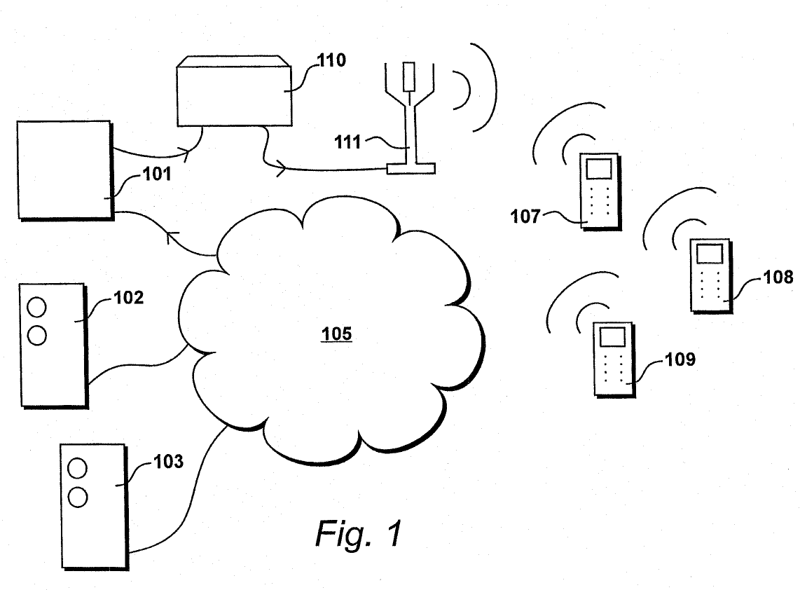

### FIG. 1

An environment for the supply of video data to mobile devices is illustrated in FIG. 1. The environment includes a video processing station 101 arranged to receive video material from video material suppliers 102, 103 via the Internet 105.

Mobile devices 107, 108 and 109, including high specification mobile cellular telephones, are configured to request video material from suppliers 102, 103 via the video processing station 101. Thus, the video processing station 101 communicates with mobile devices 107 to 109 via a mobile cellular service provider 110 having a network of cellular base stations 111.

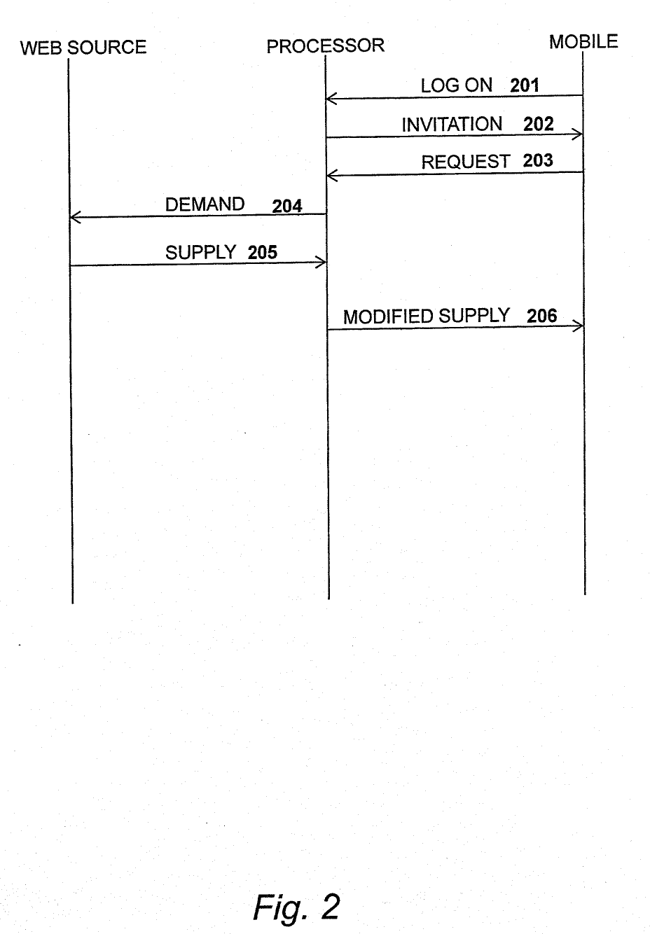

### FIG. 2

A protocol diagram illustrating operations performed within the environment of FIG. 1 is illustrated in FIG. 2.

At 201 a user using a mobile device, such as mobile device 107, logs onto the service provided by the processing station 101.

In response to this log-on operation, an invitation 202 is returned to the mobile device and in response to receiving this invitation the mobile device issues a request 203 for a specific video source.

At the processing station 101, a determination is made as to whether the request can be satisfied from previously stored material. However, assuming this is not possible, a demand 204 is made to the video source and original video material is supplied 205 back to the processing station 101.

At the processing station 101, the video material is modified to include additional material, such as advertisements. The modified supply 206 is then supplied to the requesting mobile device 107.

The material received from the video source could have been supplied directly to the requesting mobile telephone given that it has been stored in a format compatible with the radio network (110, 111) and the capabilities of the mobile device 107. Consequently, this video material will be in an encoded and compressed form (MPEG 4 for example). Consequently, difficulties arise in terms of adding material to the beginning of the video clip and/or adding material to the end of the video clip. This additional material could include advertisements, parental warnings, health warnings or any other information.

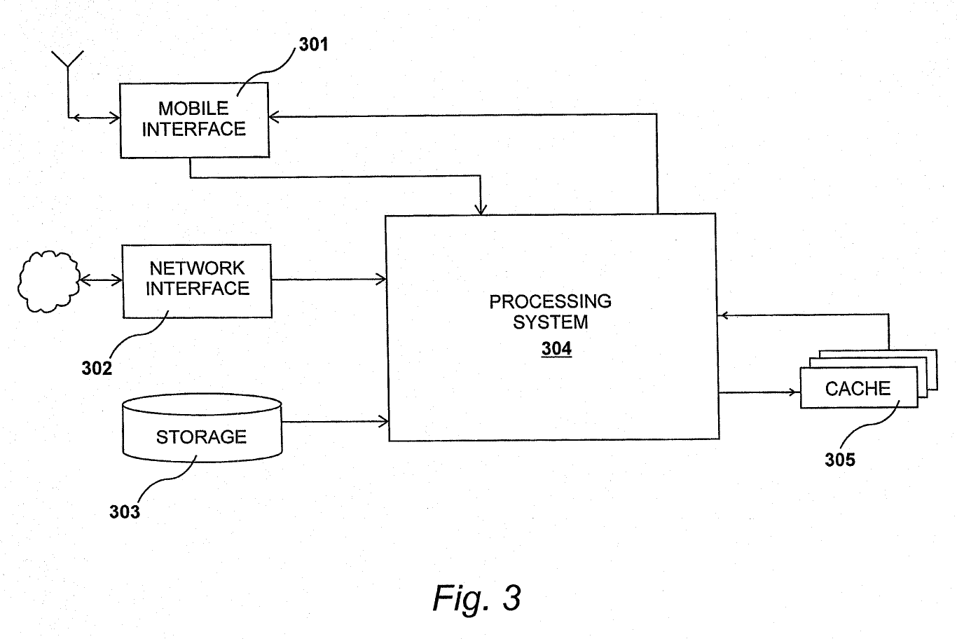

### FIG. 3

Video processing station 101 is detailed in FIG. 3. The processing station includes a first interface 301 for receiving a request from the mobile device for video data and for returning modified video data back to the requesting mobile device. The processing station also includes a second interface 302 for requesting and receiving original video data from the video sources 102, 103.

A storage device 303 is arranged to store additional video data in a local native format which in itself would not be compatible with any of the CODECs used on the mobile devices 107 to 109. A processing system 304 is configured to perform manipulations upon the data stored in storage device 303 and to effect a combining process so that video data files may be modified so as to contain additional data, usually at the start of the clip and at the end of the clip. In addition, modified assets of this type are also written to a cache 305 such that multiple requests for the same modified data may be satisfied quickly without repeating the processing and combining operations.

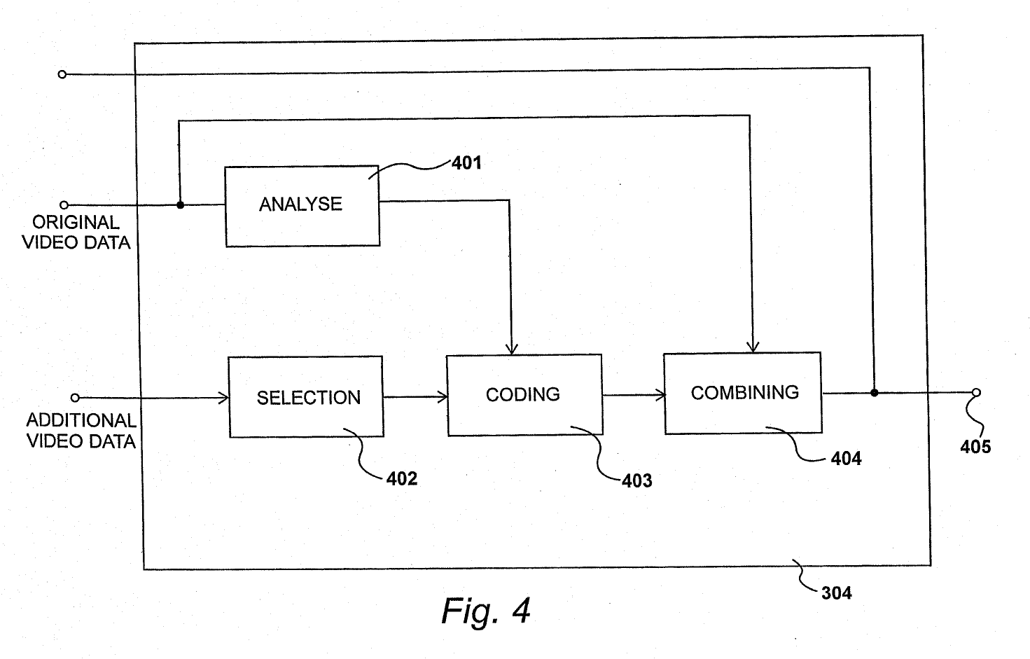

### FIG. 4

A preferred implementation for processing system 304 is identified in FIG. 4. As previously described, the apparatus, in a preferred embodiment, supplies video data to mobile devices from a plurality of video material suppliers. The video processing station includes a first interface for receiving a request from a mobile device for video data and a second interface for requesting and receiving original video data. A data store is arranged to store additional video data and the operations of these devices are responsive to a processing system 304.

In a preferred embodiment, as illustrated in FIG. 4, the processing system 304 includes an analysis sub-system 401 for analysing original coding characteristics of original video data received via the second interface. The processing system also includes a selection sub-system 402 for selecting additional data read from storage device 303. In a preferred embodiment, storage device 303 is implemented as a plurality of disc drives but it should be appreciated that other forms of storage could provide an appropriate data store.

A coding sub-system 403 codes the additional video data in accordance with the original coding characteristics as received from the analysis sub-system 401. A combining sub-system 404 combines the coded additional data from coding sub-system 403 with the original video data to produce combined video output data at 405.

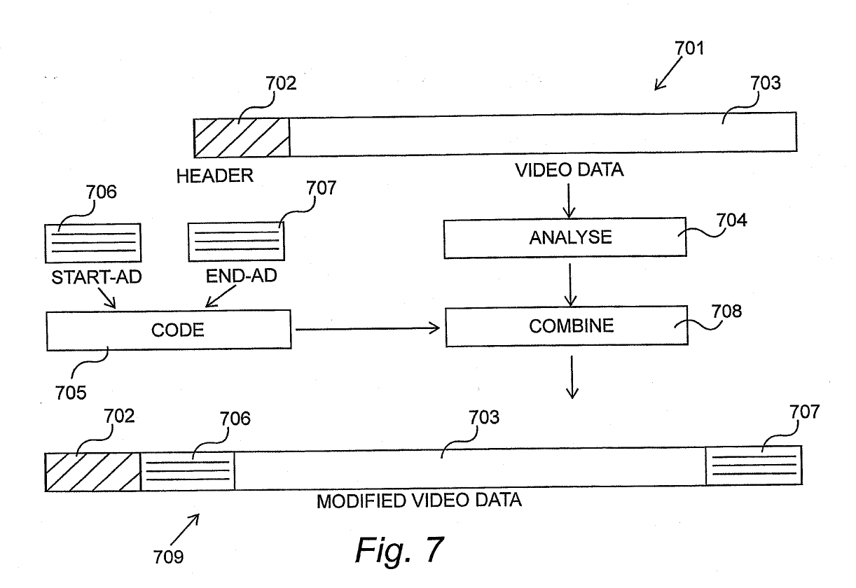

In operation, the analysis sub-system 401 effectively identifies a particular coding and decoding process, generally referred to in the art as a CODEC. In addition and where appropriate, the analysis sub-system also identifies a specific profile for the identified CODEC. Typically, this profile defines sample rates and sample definitions. Preferably, the analysis sub-system also identifies any headers present at the start of the original data file. In a preferred embodiment, the combining sub-system 404 combines coded data between the header and the original video data, as detailed with respect to FIG. 7.

Thus, it can be seen from FIG. 4 that the original video data is received at the processing system and supplied in parallel to the analysis sub-system 401 and to the combining sub-system 404. The analysis sub-system 401 identifies the type of CODEC used to code the original video data along with any other parameters associated with the CODEC, generally referred to as the profile of the CODEC.

The additional data, that is video data to be placed at the front of the original video data and/or at the end of the original video data is coded by the coding sub-system 403 so as to produce coded additional data that has technical characteristics substantially similar to the original video data. Thus, video data produced by the coding sub-system 403 appears as if it has been coded in substantially the same way as original video data received from the network interface 302. Thus, with the original video data and the additional video data now having substantially similar attributes, it is possible for an editing process to be performed by the combining sub-system 404 to produce the combined video output data.

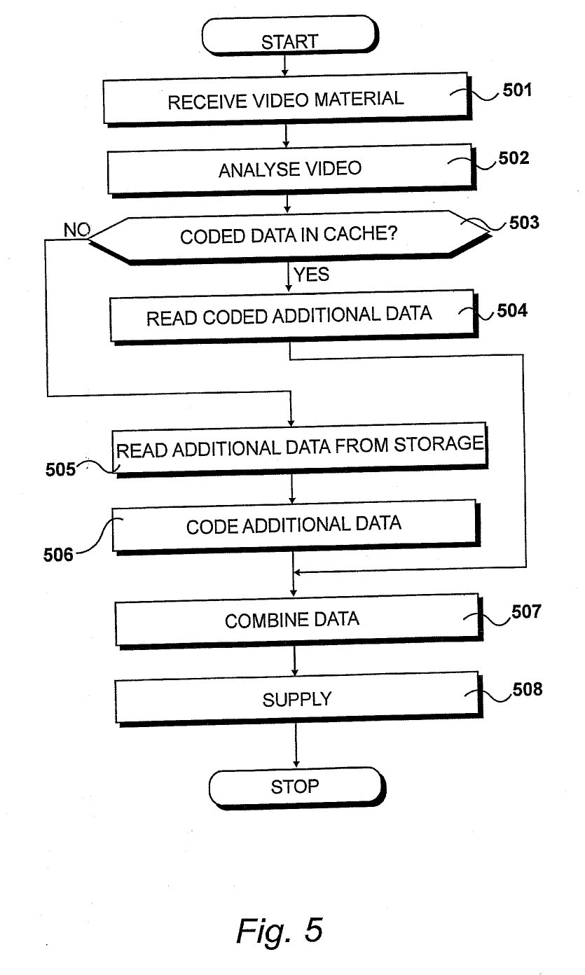

### FIG. 5

In an alternative embodiment, processing system 304 may be implemented as a programmable device programmed to perform procedures to effect an equivalent result to that produced by the embodiment detailed in FIG. 4.

Procedures performed by processing system 304, in an alternative embodiment, are detailed in FIG. 5.

At step 501 the video material is received and at step 502 an analysis is made as to the nature of that received video. The overall method, within the environment illustrated in FIG. 1, provides for the supplying of the video data to the mobile devices in response to a request for video data received from a mobile device. The original video data is received in a form that is compatible with the operational characteristics of the requesting mobile device and it is this material that is analysed at step 502. Thus, the video data is relayed to the requesting mobile device by firstly analysing the coding characteristics of the original video data. Additional data is selected from storage although in a preferred embodiment, as illustrated in FIG. 5, a question may be asked at step 503 as to whether coded data already exists in cache 305. If this question can be answered in the affirmative, the coded additional data is read at step 504. Alternatively, if the question asked at step 503 is answered in the negative, the additional data is read from storage at step 505.

When additional data has been read from storage at step 505, the additional data is coded at step 506. Thus, the coding is performed in accordance with the coding characteristics to produce coded data. Alternatively, this coded data is read from cache.

At step 507, the coded data is combined with the original data to produce combined data. This combined data is then supplied to the requesting mobile at step 508.

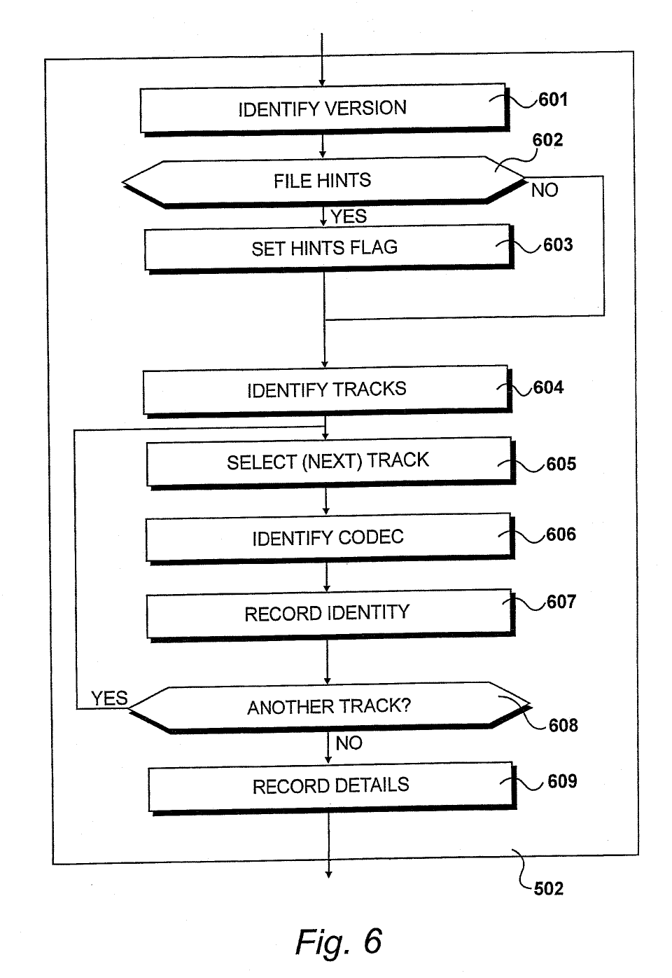

Analysis procedures performed at step 502 are substantially similar to procedures performed by the analysis sub-system 401 and are detailed in FIG. 6.

### FIG. 6

An example of procedures for analysing the type of video asset received via the network interface are detailed in FIG. 6. Video files often take the form of a container within which there are a plurality of boxes or atoms arranged in a tree-like structure. These containers have advanced as various versions have been released therefore at step 601 the version of the container is identified.

Some containers contain hints to assist when streaming video data thus at step 602 a question is asked as to whether the file contains hints and when answered in the affirmative a hints flag is set at step 503, such that coded additional video data may also include these hints where appropriate.

At step 604 tracks are identified and at step 605 a track is selected. For the selected track, the particular CODEC used is identified at step 606 and a record of this identified CODEC is made at step 607. Several CODEC types are currently available and new CODEC types are continually under development. Thus, for example, the CODEC may be identified as MPEG 4, H261, H263, MC or IAPC for example but it should be appreciated that this does not represent an exhaustive list. At step 608 a question is asked as to whether another track is to be processed and when answered in the affirmative, control is returned to step 605.

In addition to identifying the CODEC type, for each video track it is necessary to identify the width and the height of the video material and some specifications, such as H264 and MPEG 4 will include a profile definition. The profile does not actually change the decoding process but it does provide an indication of the type of material to come. Other CODEC identification parameters concern the size of the decoding buffer and the bit rate.

In addition to analysing the video material, the audio material is also analysed therefore similar procedures must be performed upon the audio tracks, hence the requirement at step 608 to consider other tracks. For sound channels this is necessary to identify whether there is one mono track or two stereo tracks and it is also necessary to identify the sample rate which typically lies between 8 kHz and 48 kHz.

### FIG. 7

An illustration of operations performed by processing system 304 are shown diagrammatically in FIG. 7. In this example, an original video clip 701 includes a header 702 and video data 703. The video clip 701 is analysed, as illustrated by 704 which firstly identifies the existence of header 702 allowing the header to be separated from the video data 703. The analysis procedure 704 also identifies the type of coding that has been performed upon the video data 703. A coding process 705 receives additional video data (in its native format) which in this example represents an advertisement 706 to be placed at the beginning of the clip and an advertisement 707 to be placed at the end of the clip. Consequently, following analysis procedure 704, additional material 706 and 707 are coded by coding process 705 such that the additional material resembles the original video data 703. That is to say, from the perspective of an independent viewer, the original video data 703 and the additional data 706, 707 would appear to have been coded by the same CODEC.

Thus, as illustrated by process 708, the material is combined to produce modified video data 709. The modified data 709 starts with header 702, followed by coded start material 706, followed by the original video data 703 and finally followed by the coded end data 707.

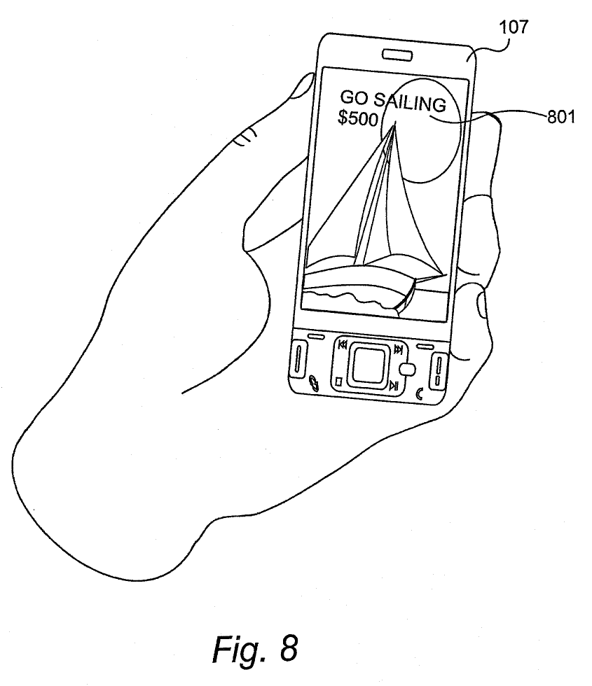

### FIG. 8

Using the procedures illustrated in FIG. 7, it is possible for a user to select encoded video data and for the data to be displayed on mobile device 107. However, in a manner that appears completely seamless to the viewer, the viewer is presented with an advertisement 801 before being in a position to view the selected material. This additional material will appear to be of substantially similar quality to the selected material, it will not require a different CODEC and no noticeable joins will be displayed. However, from the distribution perspective, the addition of this advertising material (or other material) has been achieved without recoding the whole video clip and performing sophisticated editing and recoding procedures.

The preferred embodiment has been described with respect to the supply of data to mobile devices. However, the method could be extended to other environments in which steps are performed for analysing coded input video data to determine coding characteristics of the coding performed upon the coded input video data. Additional data may be read representing an advertisement and this additional data may be coded in accordance with the coding characteristics of the input data such that the coding performed upon the additional data is performed so as to produce coded additional video data that is substantially similar to the coding performed upon the coded input video data. The coded additional video data is then combined with the coded input video data to produce combined video data.

In a preferred embodiment, the video data processing method identified above is performed in real-time in response to a request for the coded input video data. In response to this request, the combined video data may be supplied and the user would not be aware of an on-demand coding operation being performed, given that the coding operation is only performed upon the added material, i.e. the advertisement, and not upon the original input data.

An environment is facilitated in which it is possible for a user to be charged for receiving the coded input data but are a lower price if received as combined video data. Thus, the input data may be available to a user without advertisements for a fee but may be available for free when received as combined video data. Consequently, an environment is provided in which an advertiser may be charged for the supply of the video material. Thus, as an alternative to receiving a fixed charge, an advertiser may be charged each time their advertisement is deployed in response to an appropriate request being made; essentially following the “pay per click” model.

1. A video processing apparatus for supplying video data from a plurality of video material suppliers to a plurality of mobile devices, comprising:
a first interface for receiving a request from a mobile device for video data;
a second interface for requesting and receiving original video data;
a data store arranged to store additional video data; and
a processing system comprising:
an analysis sub-system for analysing original coding characteristics of original video data received via said second interface;
a selection sub-system for selecting additional video data from said data store;
a coding sub-system for coding said additional video data in accordance with said original coding characteristics to produce coded additional data; and
a combining sub-system for combining said coded additional data with the original video data, to produce a combined video output data.

2. The apparatus of claim 1, wherein said analysis sub-system identifies a particular coding and decoding CODEC.

3. The apparatus of claim 2, wherein said analysis sub-system identifies a specific profile for the identified CODEC.

4. The apparatus of claim 3, wherein said profile defines sample rates and sample definitions.

5. The apparatus of claim 1, wherein said analysis sub-system identifies a header before the start of video data.

6. Apparatus according to claim 5, wherein coded data is combined between said header and the original video data.

7. A method of supplying video data to mobile devices, comprising the steps of:
receiving a request for video data;
accepting a supply of original video data in a form compatible with operational characteristics of the requesting mobile device;
analysing the original video data to determine coding characteristics of said original video data;
reading additional video data from storage;
coding said additional video data in accordance with said coding characteristics to produce coded video data;
combining said coded video data with said original video data to produce combined video data; and
supplying said combined video data in response to said request.

8. The method of claim 7, wherein said request for video data is received from a mobile cellular telephone.

9. The method of claim 7, wherein said analysing step identifies a particular coding and decoding CODEC.

10. The method of claim 9, wherein said analysing step identifies a specific profile for the identified CODEC.

11. The method of claim 10, wherein said profile defines sample rates and sample definitions.

12. The method of claim 7, wherein said analysing step identifies a header before the start of the original video data.

13. The method of claim 12, wherein said combining step combines said coded data between the identified header and the original video data.

14. The method of claim 7, wherein coded video data is placed at least at one of:
the start of the original video data and
the end of the video data.

15. The method of claim 7, wherein said coded data conveys advertising material.

16. A method of processing video data, comprising the steps of:
analysing coded input video data to determine coding characteristics of coding performed upon said coded input video data;
reading additional video data representing an advertisement;
coding said additional video data in accordance with said coding characteristics such that the coding performed upon the additional video data to produce coded additional video data is substantially similar to the coding performed upon the coded input video data; and
combining said coded additional video data with said coded input video data to produce a combined video data.

17. The method of claim 16 performed in real-time in response to a request for said coded input video data.

18. The method of claim 17, further comprising the step of supplying said combined video data.

19. The method of claim 18, further comprising the step of charging a user for receiving said coded input data at a lower price if received as combined video data.

20. The method of claim 19, further comprising the step of charging an advertiser when combined video is supplied.
